(19) United States
(12) Patent Application Publication
(10) Pub. No.: US 2013/0089649 A1
(43) Pub. Date: Apr. 11, 2013

(54) STRIPPING METHOD AND DEVICE FOR REMOVING UNDESIRED SUBSTANCES FROM WORT

(71) Applicants: Roland Feilner, Regensburg (DE); Wolfgang Sauspreischkies, Mintraching (DE); Stephan Mayr, Regensburg (DE)

(72) Inventors: Roland Feilner, Regensburg (DE); Wolfgang Sauspreischkies, Mintraching (DE); Stephan Mayr, Regensburg (DE)

(21) Appl. No.: 13/697,856

(22) PCT Filed: Apr. 13, 2011
(86) PCT No.: PCT/EP2011/001873

§ 371 Date: Dec. 11, 2012

(30) Foreign Application Priority Data
May 14, 2010 (DE) 10 2010 028 980.9

(51) Int. Cl. C12C 7/14

(52) U.S. Cl. CPC C12C 7/14
USPC 426/475; 99/278

(57) ABSTRACT

A stripping method and a device for removing undesired flavoring substances from wort, including introducing the wort into a stripping container and producing a film that flows downward, blowing stripping gas into the stripping container in such a way that a stripping gas flow is produced, and discharging the wort.

### CROSS-REFERENCE TO RELATED APPLICATION

The present application is the United States national phase of priority of International Patent Application No. PCT/EP2011/001873, filed Apr. 13, 2011, which application claims priority of German Application No. 102010028980.9, filed May 14, 2010. The entire text of the priority application is incorporated herein by reference.

### FIELD OF THE DISCLOSURE

The disclosure relates to a stripping method for removing undesired flavoring substances from wort and a device for carrying out the method.

### BACKGROUND

A plurality of stripping systems for removing undesired flavoring substances that form due to reaction kinetics during the manufacturing process at temperatures above 80° C. is available on the market. A well-known undesired flavoring substance is, for example, dimethylsulphide (DMS mainly formed from the precursor S-methylmethione (SMM) which is formed when malt is kilned). When the reaction product is not sufficiently stripped or the wort is kept hot for an insufficient period and the precursor is thus not sufficiently split, an undesired, vegetable-like taste will form in subsequent fermentation. Therefore, the standard value of 100 μg/l should not be exceeded. Many brewers meanwhile strive for values below 50 μg/l. In optimal wort boiling, the precursor product is sufficiently split, and in boiling systems with atmospheric circulation, the formed DMS is largely stripped.

In subsequent hot break removal, however, the undesired DMS is reproduced and cannot be stripped again. Manufacturing processes with malts of bad quality and/or shortened boiling times and/or insufficient boiling rely on subsequent stripping processes to achieve the desired wort quality. However, desired substances, such as hop aromas, will inevitably also be stripped in the stripping process. Several common systems have established for stripping which are, for example, based on the supply of thermal energy, the application of a vacuum, or the creation of large surfaces.

There are systems, for example, which guide hot wort over a heated screen for thermal stripping. The injection of hot water vapor flowing through a wort column is also known for stripping undesired flavoring substances.

As a consequence of all these systems, energy must be subsequently introduced and further wort reaction occurs by the action of heat. Apart from the supply of thermal energy, methods are known which cool down wort to a temperature uncritical for the forming of DMS upstream of the whirlpool rest. However, due to the higher viscosity of the wort resulting from cooler temperatures, this will lead to a deterioration of hot break separation.

Apart from thermal stripping, systems working with vacuum have established on the market. This step can also be achieved by multiple expansion evaporation resulting in a strong boiling movement with a corresponding surface having an advantageous effect on the stripping of flavoring substances. In all expansion evaporations, a clearly worse depletion of undesired flavoring substances is disadvantageously obtained, compared to, for example, atmospheric stripping. Moreover, for the generation of a vacuum, additional energy and water consumptions are necessary.

As a third process group with respect to wort stripping, the generation of large surfaces utilizing the hot wort's own energy can be mentioned. In this case, the wort is guided into a vessel where it runs downwards, for example at the container wall.

Systems which are exclusively based on the distribution of hot wort have the disadvantage of reducing their effectiveness as the wort inlet temperatures decrease. At low temperatures, only a small amount of water vapor and undesired flavoring substances will pass over into the gaseous phase under atmospheric conditions, despite an effective surface of a maximum size.

### SUMMARY OF THE DISCLOSURE

Starting from this situation, one aspect the present disclosure is to provide a stripping method and a stripping device which reliably permit to remove undesired flavoring substances and prevent their reproduction without using high quantities of energy.

So, according to the present disclosure, wort is first introduced into a stripping vessel and a falling film flowing downwards is created. Falling film here means a film that flows down towards the outlet at an inner wall of a container. Here, the falling film is formed underneath a distribution device, preferably essentially rotationally symmetrical to the central axis of the stripping container. The falling film can be introduced then, for example, into a liquid reservoir in the lower zone of the stripping container whose surface does not exceed a maximum filling level. By generating the falling film, the surface of the wort can be essentially enlarged, so that water vapor and undesired flavoring substances, for example DMS, can be depleted via the interface to the internal gas chamber.

By blowing stripping gas into the stripping container, the exsorption or stripping of undesired flavoring substances and water vapor can be promoted. Here, the total pressure in the stripping container corresponds to the sum of all partial pressures of the different gases in the stripping container. In a balance condition, the partial pressure of a dissolved gas over the falling film is proportional to its concentration in the falling film. If now the partial pressure (that means the concentration) of the stripping gas in the stripping container is increased by introducing the stripping gas, the partial pressure of the water vapor or the undesired flavoring substances is simultaneously decreased, so that by this partial pressure shift, for example water vapor and flavoring substances are increasingly stripped from the falling film. For this, it is not necessary to heat the stripping gas, so that stripping is possible with a very low amount of energy. The depleted flavoring substances and the water vapor can then be discharged with the flow of stripping gas.

So, by blowing in the stripping gas into the external stripping container, the reduction of undesired flavoring substances, such as DMS, in the hot wort can be influenced, so that stripping can be kept at a constantly high level, even with low wort inlet temperatures or different wort volume flows.

Particularly advantageously, the method is employed for wort freed from hot break which is further cooled after stripping. If the stripping process is carried out after hot break separation, undesired flavoring substances which are reproduced in hot break separation can be effectively removed. Since in the method according to the disclosure, no further thermal energy is supplied, their reproduction during and after the stripping process can be prevented. If the wort is already freed from hot break in the stripping process, the falling film can be better and more uniformly formed.

It is particularly advantageous if the outlet temperature of the wort is lower than the inlet temperature of the wort. This means that the wort flowing down in the falling film is cooled by the stripping gas. This means that by the stripping gas, on the one hand more water and flavoring substances pass over into the gaseous phase due to the partial pressure shift, but on the other hand, a new formation of undesired flavoring substances is also prevented by the temperature reduction of the wort. Since no additional energy must be supplied, the stripping gas can be unheated and thus e.g. have ambient temperature. The stripping gas can thus preferably have room temperature or expansion temperature, that means a temperature<40° C.

According to a preferred embodiment of the present disclosure, the volume flow rate of the stripping gas is adjusted or controlled, respectively, so that, independent of the wort inlet temperature, a constant amount of water vapor and undesired flavoring components can be stripped.

In particular, the volume flow rate of the stripping gas is adjusted depending on the temperature difference ΔT between the inlet temperature and the outlet temperature of the wort, and it is advantageously automatically controlled. Since the temperature decrease ΔT is proportional to the forming water vapor or the flavoring components that have passed over into the gaseous phase, i.e. the amount of stripping gas, the stripping amount can be exactly adjusted by the adjustment or control of the volume flow rate of the stripping gas.

One can react to lower wort inlet temperatures with a higher amount of stripping gas. Such a method can be easily and inexpensively realized. So, a constant amount of stripping gas can also be adjusted at different wort inlet temperatures, and also independent of the volume flow rate of the wort. The temperature difference can be determined by measuring the inlet and outlet temperatures of the wort and by subtraction. Such a control is particularly simple. However, it is also possible to adjust the stripping gas volume in response to a value proportional to the temperature difference, which is determined, for example, on the basis of the inlet temperature of the wort and the volume flow rate of the wort when the falling film surface is known.

Advantageously, the volume flow rate of the stripping gas is adjusted or controlled such that a predetermined temperature difference ΔT results which is within a range of 0.1 to 10° C., in particular 0.1-5° C. In this range, the undesired flavoring substances can be particularly well stripped. This means that a desired ΔT is determined for various sorts, and thus a certain amount of undesired flavoring components can be stripped.

Advantageously, at least one of the following group is used as stripping gas: inert gas, air, CO₂, N₂, O₂. Preferably, the stripping gas is sterile and free from water vapor. If N₂ is used, it can be generated particularly inexpensively from ambient air by a nitrogen generator.

By introducing the stripping gas, a slight overpressure can prevail in the stripping container, compared to atmospheric pressure. This overpressure, however, is maximally 250 mbar in addition to atmospheric pressure.

It is advantageous to introduce the stripping gas into the gas chamber of the stripping container in particular centrally via an inflow opening directed upwards or downwards, and/or to directly blow it into the filling level of the wort. If the stripping gas is guided into the gas chamber via an inflow opening directed downwards, one will have the advantage that also the minor surface of the wort in the lower zone of the stripping gas container is “blown off”, whereby here, too, the temperature is effectively further reduced and hydrogen and flavoring components pass over into the gaseous phase.

In a particularly preferred embodiment, the stripping gas will rise to the top in a reverse current to the falling film guided downwards.

The inventive device for carrying out the method comprises a stripping container, a wort feed, a distributor device for generating a falling film, a wort drain and stripping gas supply and discharge lines which generate a flow of stripping gas in the stripping container.

As stripping gas, a wort copper, a mash vessel, a whirlpool or other containers occurring in a brewery can also be employed apart from an external container.

A corresponding device can be manufactured relatively easily and inexpensively. Advantageously, the device comprises a temperature sensor for measuring the inlet temperature of the wort, and a temperature sensor for measuring the outlet temperature of the wort. The device can equally comprise a control valve for adjusting the volume flow rate of the stripping gas. With such an arrangement, the volume flow rate of the stripping gas can be adjusted e.g. in response to a temperature difference ΔT of the inlet and outlet temperatures.

To be able to also allow for thermal fluctuations of the wort, the volume flow rate of the gas is advantageously not only adjusted to a certain ΔT, but a control device is also provided which controls the volume flow rate of the stripping gas in response to the temperature difference ΔT between the inlet temperature and the outlet temperature of the wort.

To realize a uniform flow of stripping gas, the stripping gas supply line is advantageously designed such that it comprises an inflow opening located centrally in the container, preferably facing downwards.

Different distributor devices can be provided for generating the falling film. It is possible, for example, to provide a swirl inlet nozzle which makes the wort rotate such that it will flow down the container's inner wall as a falling film from an upper zone of the container. However, it is also possible to provide a wort directional screen, in particular a double screen which sprays the wort in a thin film towards the container's inner wall, so that a falling film will flow down the container's inner wall. It is finally also possible to provide an annular conduit in the upper zone of the container which comprises either several openings arranged at its circumference or an annular gap which directs the wort to the container's inner wall, such that the wort can flow down the container's inner wall as a falling film.

It is particularly advantageous to provide a brewhouse arrangement wherein the stripping device according to the disclosure is arranged between the apparatus for hot break separation and the apparatus for wort cooling. Then, the inlet temperature of the wort into the stripping container has a temperature within a range of 80-100° C.

It is advantageous for the stripping container to comprise a bottom whose diameter diminishes downwards and which preferably has a conical design and/or a sensor for level control. By the conical bottom, in the outlet zone of the stripping container, a high filling level with a simultaneously small volume is possible which ensures sufficient admission pressure for the subsequent wort pump. By the sensor for level control, a desired filling level can be determined.

### BRIEF DESCRIPTION OF THE DRAWINGS

The disclosure will be illustrated below with reference to the following figures.

FIG. 1 roughly schematically shows a stripping container according to a first embodiment of the present disclosure.

FIG. 2 roughly schematically shows a stripping container according to a further embodiment of the present disclosure.

FIG. 3 roughly schematically shows a device according to the present disclosure including a stripping gas control.

FIG. 4 shows a graph showing the volume flow rate of the stripping gas in response to the inlet temperature of the wort at a predetermined ΔT.

FIG. 5 shows a graph wherein the amount of residual DMS (in %) is plotted versus ΔT according to the present disclosure.

FIG. 6A schematically shows a longitudinal section through a swirl element.

FIG. 6B perspectively shows the inset in the swirl element.

FIG. 7 schematically shows a longitudinal section through a stripping container with a double screen as wort distributing device.

FIG. 8 roughly schematically shows a brewhouse arrangement with an apparatus for hot break separation, a stripping container and a wort cooler.

### DETAILED DESCRIPTION OF THE PREFERRED EMBODIMENTS

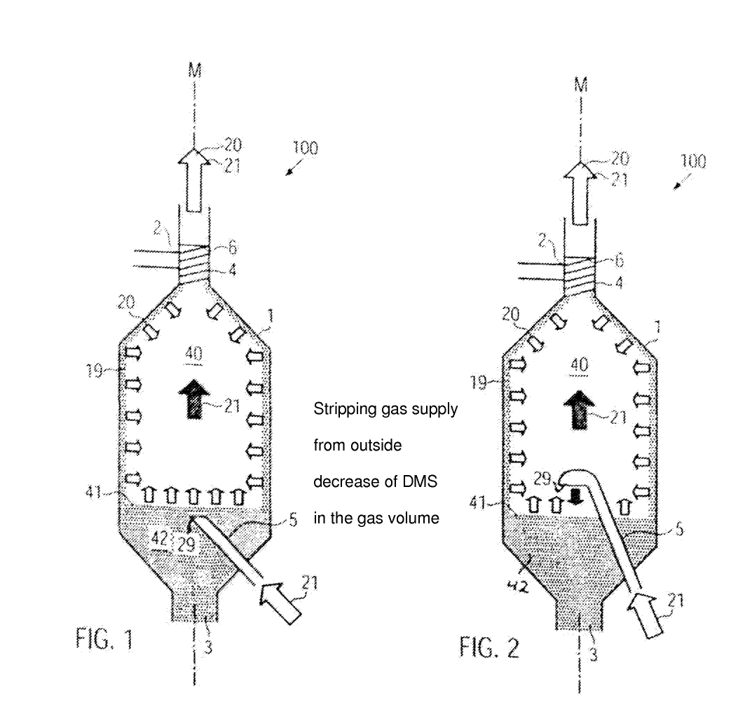

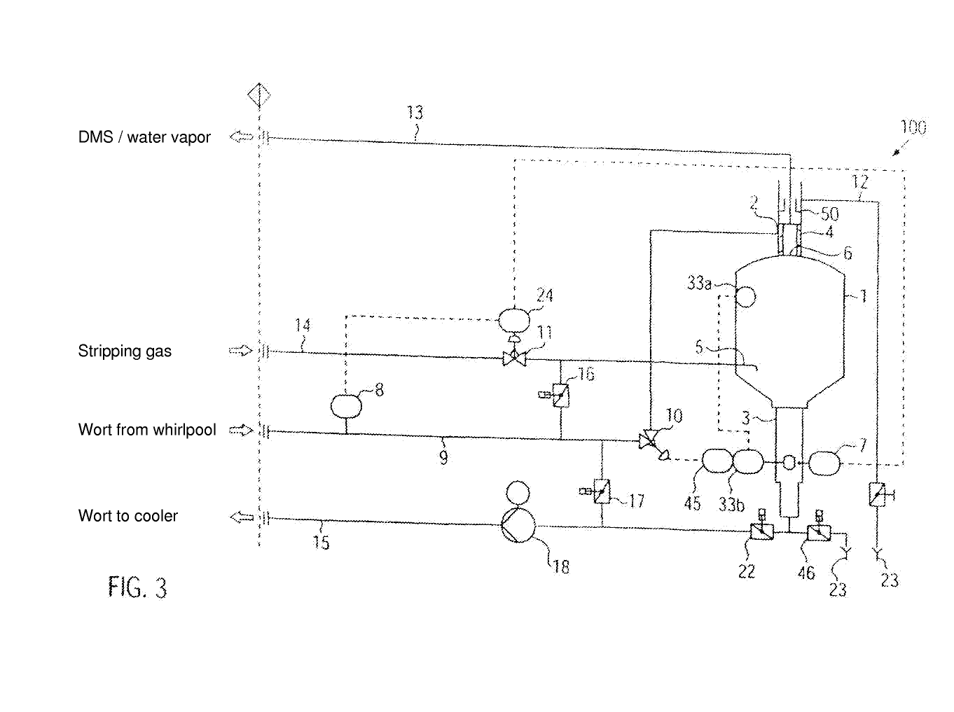

FIG. 1 schematically shows an embodiment of a stripping container 1 of a stripping device 100 according to the present disclosure. The stripping container 1 comprises a lower zone with a bottom whose diameter diminishes downwards and which has an essentially conical design, as can be taken from FIG. 1. By this bottom shape, a high filling level with a simultaneously small volume is possible, ensuring sufficient admission pressure for a subsequent wort pump 18 (see e.g. FIG. 3). The upper zone is also embodied such that its diameter diminishes towards the top. Here, the upper zone also has an essentially conical design, but it could also be of a rounded shape. Such a stripping container can comprise, for example, a volume of 1-5 m³. In the upper zone of the stripping container, a wort feed 2 is provided via which wort can be introduced into the stripping container.

The inlet 2 is provided with a distributor device 4 which is designed such that it forms a falling film 19 at an internal surface of the container. Falling film here means a film that flows down at an inner wall of a container towards the wort drain 3. The falling film is here formed underneath the distributor device 4, preferably rotationally symmetric to the central axis M of the stripping container. The falling film can then flow, for example, into a liquid reservoir 42 in the lower zone of the stripping container 1. The thickness of the falling film is within a range of 0.1-1 mm. The falling film has two interfaces, one being directed to the container's inner wall and the other one being directed to the inner gas chamber 40. Thus, a large surface of the wort is efficiently produced.

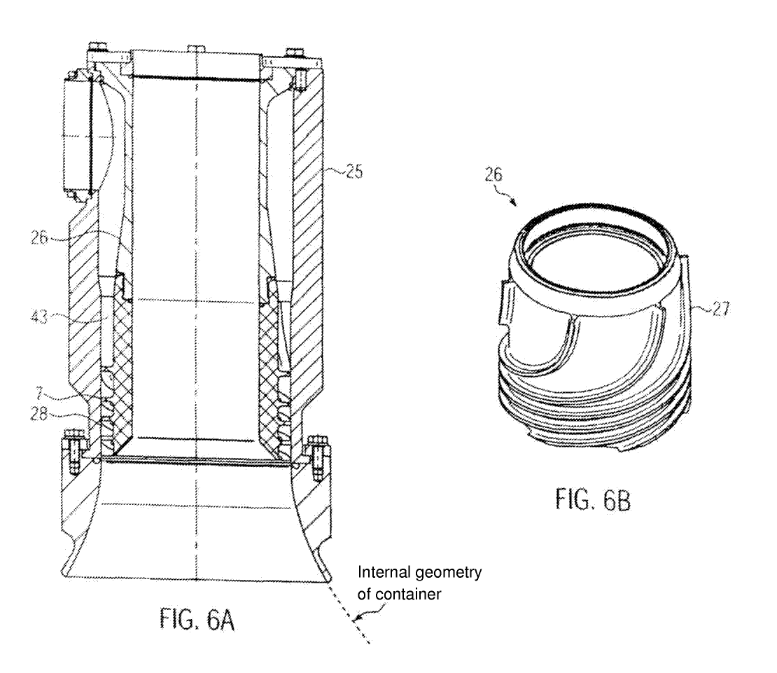

In this embodiment, a swirl inlet nozzle is provided as distributor device 4. Such a swirl inlet nozzle is shown more in detail in FIGS. 6A and B. As can be seen in FIG. 6A, the swirl inlet nozzle comprises an essentially hollow cylindrical outer body 25 with a wort inlet and an inset 26 embodied as hollow cylindrical sleeve and having a smaller diameter than the outer body 25, such that a liquid channel 43 forms between the inset and the outer body. The inset 26 has, at least in the lower zone, as can be taken from FIG. 6B, several spiral projections 27 which adjoin the inner wall of the body 25 in the inserted state and essentially form spiral channels 28 for the wort. The wort which is conducted through the recess 43 and the channels 28 is thus essentially tangentially accelerated and can be directed to flow against the inner wall of the stripping housing via several annularly distributed gap sections between the outer body 25 and the inset 26 in the lower zone of the inlet nozzle. This means that the wort is rotated and flows downwards in a thin, turbulent falling film 19 over the complete inner surface of the container. By the flow channels 28 in the inlet nozzle, the wort has an increased speed and thus an increased dynamic pressure which promote the stripping of undesired flavoring substances when it enters the stripping container.

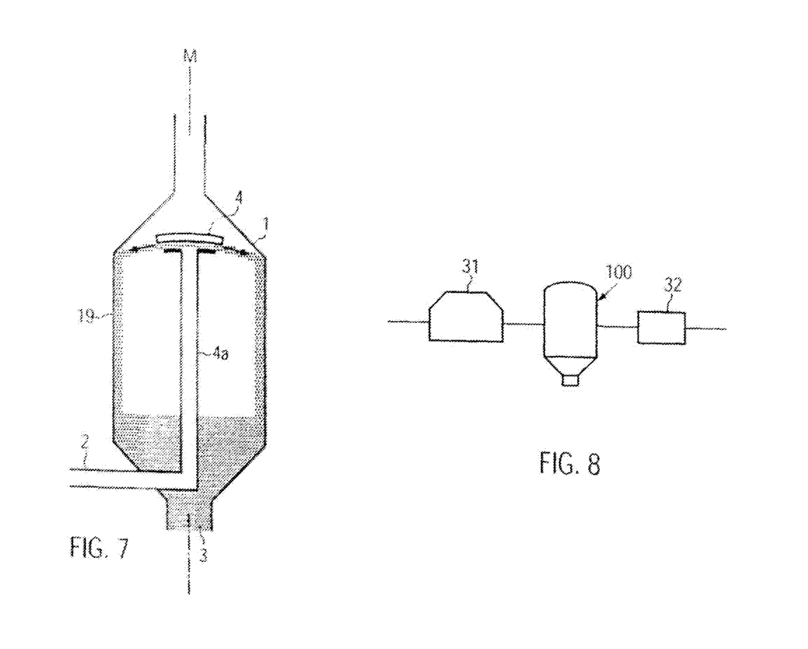

The use of this swirl element is particularly advantageous. However, it is also possible to use other distributor devices, for example the double screen shown in FIG. 7. A distributing pipe 4a e.g. follows the inlet 2 and preferably extends along the central axis M to an upper zone of the stripping container 1. A lower, essentially rotationally symmetric screen bent downward is disposed at the upper end of the pipe 4a. An also essentially rotationally symmetric upper screen is disposed at a distance to this screen and has a larger diameter than the lower screen and is also bent downwards in this embodiment. Between these two screens, an annular gap is formed via which the rising wort is sprayed to the outside to the container's inner wall of the stripping vessel 1 and from there can flow downwards as a falling film as is represented by the arrows.

While it is not represented, it is, for example, also possible to provide an annular conduit in the upper zone of the stripping container which comprises either several openings arranged at the circumference or an annular gap guiding the wort to the container's inner wall, such that the wort can flow down at the container's inner wall as a falling film.

Apart from the wort feed and drain 2, 3, the container also comprises a stripping gas supply line 5 in the lower zone of the container and a stripping gas discharge line 6, preferably in the upper zone of the container. By the stripping gas supply and discharge lines, a flow of stripping gas 21 can be generated. In this embodiment, the stripping gas discharge line is disposed at the upper end of the container and extends through the inner inset 26 of the nozzle 4. As can be taken from FIG. 1, a gas line projects into the container 1 from the lower part of the container 4. The gas line has an opening 29. The opening 29 is disposed at a level which is arranged underneath a mirror surface 41 of the wort reservoir 42. The maximum filling level 41 can be determined and adjusted by a level control as will be illustrated more in detail below. Via the opening 29, the stripping gas 21 can enter the wort and then the gas chamber 40 of the container. The line or opening, respectively, could also project above the surface 41 from the wort into the gas chamber.

The embodiment shown in FIG. 2 corresponds to the embodiment shown in FIG. 1, with the exception that the opening 29 is directed above the surface 41 downwards, i.e. towards the surface 41 of the wort. The opening 29 is preferably located in the region of the central axis M of the container. When the stripping gas is introduced into the gas chamber 40 via an inflow opening directed downwards, one obtains the advantage that also the mirror surface 41 of the wort is “blown off” in the lower zone of the stripping gas container, whereby more flavoring substances and water vapor, respectively, can be stripped. As an alternative or in addition, the stripping gas can also be directly blown in into the reservoir 42 via a corresponding supply line.

So, the stripping gas, e.g. an inert gas, sterile air, CO₂, O₂ or N₂, can flow to the top via the stripping gas supply line 5 in a reverse current to the flowing down falling film 19.

By blowing in the stripping gas into the stripping container 1, the stripping of undesired flavoring substances and water vapor 20 can be controlled.

Here, the total pressure p_{g} in the stripping container corresponds to the sum of all partial pressures pi of the different gases in the gas chamber 40 of the stripping container.

p_{g}=Σpᵢ

p_{g}=(pₐᵢᵣ+p_{DMS}+p_{residual components})+p_{H}_{₂}_{O}

wherein e.g. p_{g}=1000 mbar; pₐᵢᵣ+p_{DMS}+p_{residual components}=150 mbar; p_{H}_{₂}_{O}=850 mbar (at T=95° C.).

The partial pressures act as the corresponding volumes. The partial pressure of a dissolved gas over the falling film, i.e. in the gas chamber 40, is proportional to its concentration in the falling film in balance. If now the partial pressure of the stripping gas in the stripping container is increased by introducing the stripping gas 21, the partial pressure of the water vapor or the undesired flavoring substances 20, respectively, is simultaneously reduced, so that by this partial pressure shift, for example water vapor and DMS, and also the other flavoring components are increasingly exorbed. For this, it is not necessary to heat the stripping gas, so that stripping is possible with a very low amount of energy. The depleted flavoring substances and the water vapor can then be discharged with the flow of stripping gas.

So, by blowing in the stripping gas into the external stripping container 1, the reduction of undesired flavoring substances in the hot wort can be selectively influenced in response to the volume flow rate of the stripping gas, so that stripping can be kept at a constantly high level, even with low wort inlet temperatures or different wort volume flow rates.

The wort cools down as it is flowing down as a falling film. The temperature decrease is proportional to the volume flow rate of the stripping gas and thus also to the amount of stripped water or flavoring components, respectively, the stripping gas amount maintaining—corresponding to an efficiency—the driving gradient between the water vapor and flavoring substances at the falling film to the interior of the container 40.

Thus, the volume flow rate of the stripping gas can be adjusted, in particular automatically controlled, in response to the temperature difference ΔT between the inlet temperature and the outlet temperature of the wort to thus adjust a constant amount of stripped water or flavoring components, independent of the wort inlet temperature or the wort volume flow rate. Since the outlet temperature of the wort is lower than the inlet temperature of the wort, the stripping gas can have room temperature or expansion temperature, but normally a temperature of <40° C., and is therefore unheated, but neither cooled. It showed that it is advantageous, as will be illustrated more in detail below, to adjust the volume flow rate of the stripping gas such that a predetermined temperature difference ΔT is within a range of 0.1 to 10° C., in particular 0.1-5° C. A certain ΔT can be determined for different wort sorts by experiments (e.g. by the quantitative analysis of DMS), so that the water vapor formation and the amount of stripped flavoring components also proportional to ΔT, respectively, can be adjusted.

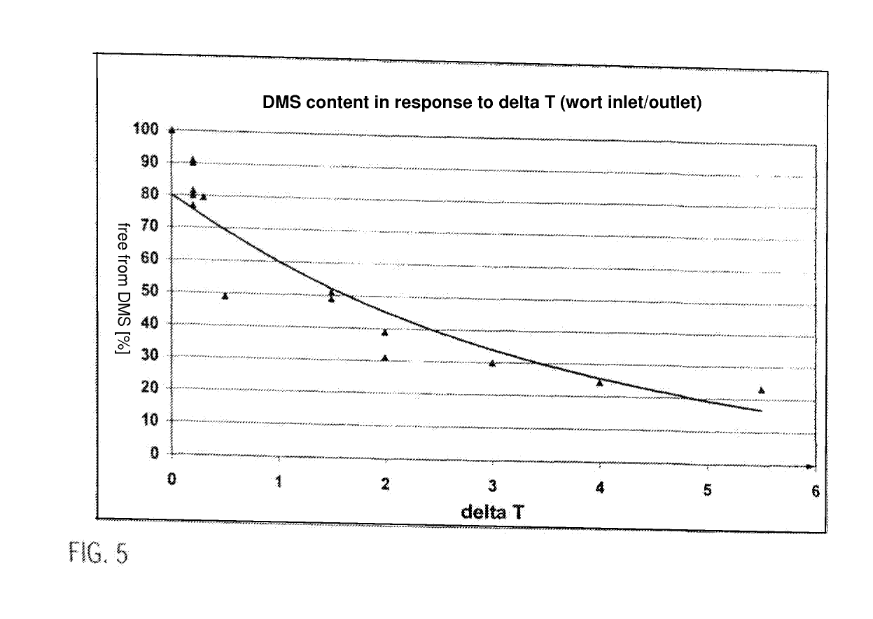

The next diagram shows the content of free DMS in wort, which was stripped with the above described device, in response to ΔT. As can be seen in the graph of FIG. 5, the amount of stripped DMS is proportional to ΔT between the inlet temperature and the outlet temperature of the wort. This means that, as ΔT rises, the residual amount of free DMS decreases. Thus, a desired ΔT and thus a desired amount of stripped DMS can be determined by a sort parameter. It was determined, for example, in the diagram shown in FIG. 5 that a range ΔT between 0.5 and 3° K is advantageous as this range corresponds to a DMS reduction which is sufficient for a certain sort, where it is simultaneously prevented that too many desired flavoring substances are stripped. Now, a corresponding ΔT range or a certain value for ΔT can be determined.

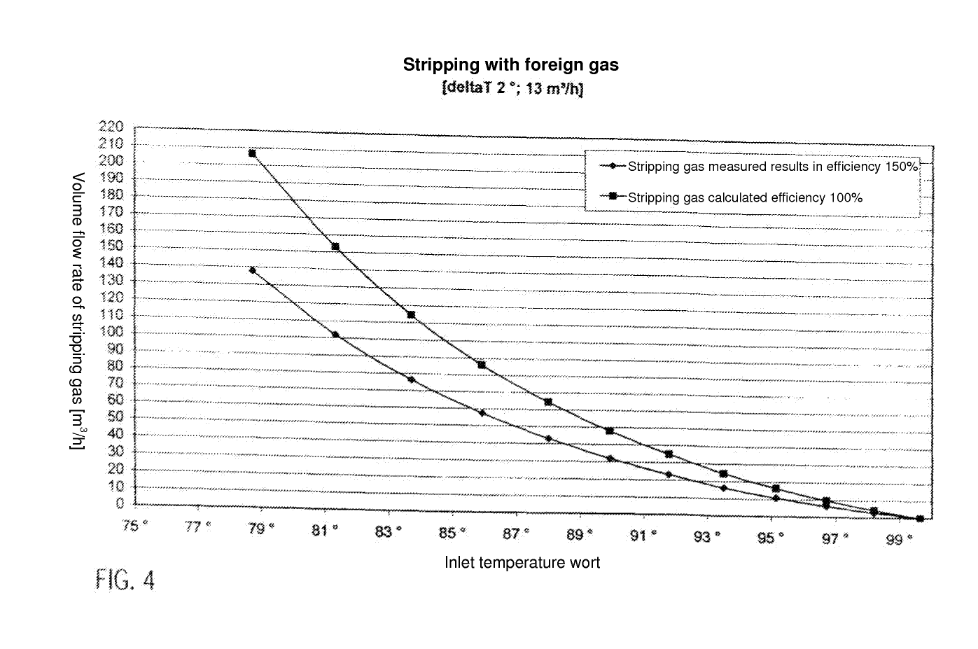

FIG. 4 shows the volume flow rate of stripping gas in m³ per hour at different wort inlet temperatures for ΔT=2° K and a stripping performance of 13 m³/h. The upper curve shows the calculated amount of stripping gas. The lower curve shows the measured amount of stripping gas in practice for maintaining ΔT. The efficiency for the calculated curve is here 100%, the efficiency being defined by the partial pressure differences of the gases located in the gas chamber and the dynamic pressures of the liquid flows, and it can amount to up to 150% in practice. This means that, since the stripping gas flows in a reverse current over the wort surface, and due to the dynamic pressures of the flowing wort in the outlet of the nozzle and in the falling film, stripping is increased, and a lower flow rate of stripping gas is required in practice, compared to the theoretically determined flows, for stripping a determined amount of undesired flavoring substances. So, the efficiency here corresponds to a ratio of the theoretical amount of stripping gas to the actual amount of stripping gas.

As can be taken from FIG. 4, a suited volume flow rate for the stripping gas of about 10 to 25 m³ per hour results for a wort inlet temperature within a range of about 93 to 97° C. The volume flow rate of the stripping gas can here be adjusted via a control valve, or else be automatically controlled by automatic control, so that an exact amount of undesired flavoring substances can always be stripped.

FIG. 3 shows a corresponding embodiment that permits a corresponding control of the flow rate of the stripping gas. FIG. 3 comprises a stripping container 1 as it was described before in connection with FIGS. 1 and 2. The stripping container 1 here furthermore comprises an apparatus for level control, such that a maximum filling level 41 in the container 1 can be adjusted. In this embodiment, the level control comprises two pressure sensors 33a and 33b. The pressure sensor 33b measures the pressure in a lower zone, in particular in the outlet zone of the container 1, and the pressure sensor 33a measures the pressure in an upper zone of the container 1 which lies above the maximum filling level. By measuring the differential pressure, a certain filling level can be adjusted by means of a controller 45. The controller 45 activates a control valve 10 in a wort line 9 and thus adjusts a determined volume flow rate of the wort. A discharge valve 22 in a discharge line 15, which guides stripped wort to a cooler, can also be connected with the controller 45. By activating the two control valves, a certain filling level can be adjusted. When the filling level is controlled, the wort is then continuously fed and discharged. Furthermore, a wort pump 18 is provided which delivers the wort at a constant volume flow rate from the controlled filling level in the container 1 to the wort cooler. In the wort line 15, a control valve 46 is moreover arranged via which liquid from the stripping container (e.g. cleaning liquid) can be discarded via the channel 23.

Finally, the line 14 for the stripping gas, e.g. CO₂, is provided. The control valve 11 is located in this line, by which the volume flow rate of the stripping gas which is supplied to the container 1 can be adjusted. Moreover, the arrangement comprises a temperature sensor 8 which is here provided in the wort line 9 to measure the temperature of the incoming wort. Finally, a further temperature sensor 7 is provided in the outlet zone of the container 1 which determines the outlet temperature of the wort. The temperature sensor 7 is here disposed in the lower conical end of the container 1, but it could also be arranged, for example, in the line 15. The temperature sensors 8 and 7 are connected with a controller 24 which controls the volume flow rate of the stripping gas via the control valve 11 in response to the temperature difference ΔT.

In the upper zone of the container 1, here a condensate return protection 50 as well as a condensate line 12 via which the condensate can be discarded via the drain 23 are moreover shown. Via the line 13, the stripped water vapor and the other stripped components can be discharged and condensed and discarded. The energy of the condensed water vapor can here be recovered and reused.

Between the lines 14 and 9, a valve 16 is provided for rinsing purposes.

Between the lines 9 and 15, a valve 17 for bypassing the stripping is provided.

FIG. 8 shows a brewhouse system with an apparatus for hot break separation 31, for example a whirlpool, the inventive stripping device 100 with a stripping container 1, and a wort cooler 32 disposed downstream thereof.

Below, a method according to the disclosure will be illustrated more in detail with reference to FIGS. 1, 2 and 3.

First, a desired ΔT is determined in advance for a certain wort type, as was explained in connection with FIG. 5. This ΔT then corresponds to a certain amount of DMS which is to be stripped. This can be determined, by way of example and as is represented in FIG. 5, by a determined control curve.

Here, the wort can be conducted via the line 9 to the feed 2, in particular after hot break separation, e.g. from the whirlpool. The temperature of the incoming wort is, for example, 80 to 100° C. As described above, a certain volume flow rate is adjusted via the control valve 10 such that a certain filling level of the wort 41 in the container 1 can be adjusted. The discharge valve 22 is correspondingly adjusted. The volume flow rate of the wort is e.g. 5-60 m³/h. The wort flowing in via the feed 2 is distributed by the distributor device 4, so that a falling film 19 flowing downwards is produced (see also FIGS. 1 and 2). The surface of the falling area is within a range of 5 to 20 m².

Via the line 14, stripping gas 21 is introduced via the stripping gas inlet 5 into the container 1. The stripping gas 21 flows to the top in a reverse current to the falling film 19 (also see FIGS. 1 and 2) and escapes via the stripping gas discharge line 6 and the line 13. In the process, water and flavoring components 20, as explained above, are depleted.

During stripping, a slight overpressure can be formed, depending on the air pressure of the ambient atmosphere. The wort cools down during stripping, and the temperature of the introduced wort is determined by the temperature sensor 8, and that of the cooled wort is determined by the temperature sensor 7. If now, for example, ΔT is smaller than ΔTₙₒₘᵢₙₐₗ, the stripping gas flow is increased such that ΔT corresponds to a desired value or value range. In the process, the controller 24 correspondingly activates the control valve 11. If ΔT is greater than ΔTₙₒₘᵢₙₐₗ, the volume flow rate of the stripping gas is reduced by the control valve 11 until ΔT reaches again a corresponding nominal value or lies within a corresponding nominal value range. By adjusting the stripping gas flow in response to the temperature difference ΔT, thus a constant desired amount of undesired flavoring substances 20 can be stripped at all times. The stripped wort can be supplied to a wort cooler (32) via the wort pump 18 and line 15 (see FIG. 8) and cooled down, for example, to 1-25° C. In the method, ΔT is preferably within a range of 0.1 to 10° C., in particular 0.1-5° C.

In the above described embodiments, the temperature difference was determined by measuring the inlet and outlet temperatures of the wort via the corresponding sensors. However, it is also possible to adjust or control the stripping gas volume in response to a value proportional to the temperature difference, which is determined, for example, on the basis of the inlet temperature of the wort and the volume flow rate of the wort with a known falling film surface.

What is claimed is:

1. A stripping method for removing undesired flavoring substances from wort, comprising:
introducing the wort into a stripping container and producing a falling film flowing downwards,
blowing in stripping gas into the stripping container, such that a stripping gas flow is generated, and
discharging the wort,
wherein the volume flow rate of the stripping gas is adjusted or controlled, respectively, in response to a temperature difference ΔT between the inlet temperature and the outlet temperature of the wort or a value proportional to the temperature difference.

2. The stripping method according to claim 1, wherein the wort has been subjected to hot break separation before being introduced into the stripping container and is subjected to wort cooling after having been discharged.

3. The stripping method according to claim 1, wherein the outlet temperature is lower than the inlet temperature of the wort.

4. (canceled)

5. The stripping method according to claim 1, wherein the volume flow rate of the stripping gas is adjusted or controlled such that a predetermined temperature difference ΔT of the wort lies within a range of 0.1 to 10° C.

6. The stripping method according to claim 1, wherein as the stripping gas, at least one from the following group is used: inert gas, air, CO₂, N₂, and O₂.

7. The stripping method according to claim 1, wherein during stripping a slight overpressure prevails in response to the air pressure of the ambient atmosphere.

8. The stripping method according to claim 1, wherein the stripping gas is one of:
introduced into the gas chamber of the stripping container,
is directly blown into the filling level of the wort, and
a combination thereof.

9. The stripping method according to claim 1, wherein the stripping gas rises to a top of the stripping container in a reverse current to the falling film guided downwards.

10. A device for performing the method according to claim 1, comprising:
a stripping container,
a wort feed,
a distributor device for generating a falling film,
a wort drain, and
stripping gas supply and discharge lines, which produce a stripping gas flow in the stripping container.

11. The device according to claim 10, wherein the device comprises a temperature sensor for measuring the inlet temperature of the wort, a temperature sensor for measuring the outlet temperature of the wort, and a control valve for adjusting the volume flow rate of the stripping gas.

12. The device according to claim 11, and further comprising a controlling device which controls the volume flow rate of the stripping gas in response to the temperature difference ΔT between the inlet temperature and the outlet temperature of the wort.

13. The device according to claim 10, wherein the stripping gas supply line comprises an inflow opening centrally in the stripping container.

14. The device according to claim 10, wherein the distributor device comprises a swirl inlet nozzle which rotates the wort, a wort directional screen, or an annular conduit, the annular conduit provided with several openings disposed at the circumference or an annular gap.

15. The device according to claim 10, wherein the stripping container comprises one of a bottom whose diameter diminishes downwards, a sensor for level control, and a combination thereof.

16. A brewhouse arrangement with a stripping device, the stripping device comprising:
a stripping container,
a wort feed,
a distributor device for generating a falling film,
a wort drain, and
stripping gas supply and discharge lines, which produce a stripping gas flow in the stripping container,
wherein the volume flow rate of the stripping gas is adjusted or controlled respectively, in response to the temperature difference ΔT between the inlet temperature and the outlet temperature of the wort or a value proportional to the temperature difference,
and the brewhouse further comprising an apparatus for hot break separation, an apparatus for wort cooling, and the stripping device is disposed between the device for hot break separation and the device for wort cooling.

17. The stripping method according to claim 1, wherein the inlet temperature of the wort into the stripping container is within a range of 80°-100° C.

18. The stripping method according to claim 3, wherein the stripping gas has a temperature of <40° C.

19. The stripping method according to claim 5, wherein the predetermined temperature difference ΔT of the wort lies within the range of 0.1 to 5° C.

20. The stripping method according to claim 6, wherein where, when N₂ is used, N₂ is preferably generated from ambient air by a nitrogen generator.

21. The stripping method according to claim 7, wherein the overpressure being preferably maximally 250 mbar above the air pressure of the ambient atmosphere.

22. The stripping method according to claim 8, wherein when the stripping gas is introduced into the gas chamber of the stripping container, the stripping gas is introduced centrally via an inflow opening directed to a top or a bottom.

23. The device according to claim 13, wherein the inflow opening faces downwards.

24. The device according to claim 15, wherein the bottom has a conical design.
